(19) United States
(12) Patent Application Publication
(10) Pub. No.: US 2010/0012470 A1
(43) Pub. Date: Jan. 21, 2010

(54) Electrical controller

(76) Inventor: Rodney W. Pince, Trego, WI (US)

Correspondence Address: Marvin Jacobson;Jacobson and Johnson, Suite 285, One West Water Street, St. Paul, MN, 55107-2080, US

(21) Appl. No.: 12/218,549

(22) Filed: Jul. 17, 2008

(51) Int. Cl. H01R 39/60

(52) U.S. Cl. 200/19.09

(57) ABSTRACT

A segmented rotor comprises two disc-like members electrically charged with opposite polarities having circumferentially spaced interleaved fingers extending in an axial direction electrically insulated from one another and rotationally driven by an insulated shaft. Suitable brushes extend radially into contact with the interleaved fingers to produce repetitive alternate polarity electrical signals at each brush as the rotor rotates. The electrical signals are fed to utilization devices to control their operation.

### FIELD OF THE INVENTION

This invention is aimed at providing a device for continuously and repetitively developing and producing electrical signals which are sent directly to electrically operated devices or utilization devices to operate them in a controlled sequential manner. More specifically the device incorporates a rotationally driven rotor or armature to repetitively produce a series of electrical energy pulses of alternate polarities which can then be coupled electrically directly to utilization devices which respond to the electrical pulses. The produced electrical signals can be used, for example, for controlling the time of operation of utilization devices or for controlling the sequence of operation and for similar operations.

### SUMMARY OF THE INVENTION

An embodiment of the invention comprises a two piece segmented rotor made out of a good electrically conductive material with each half of the rotor electrically insulated from the other but with interleaved extensions or fingers also insulatably separated from one another. The segmented rotor is conventionally enclosed with a suitable outer housing and has a common shaft which is rotationally driven by a suitable mechanical drive source such as a motor. Each half of the segmented rotor is electrically energized with an opposite polarity DC or direct current from a suitable source so that one half of the rotor and its associated fingers is fixedly polarized positive and the other half with its corresponding interleaved fingers is energized with a negative polarity voltage.

Electrically conductive brushes are mounted in suitable holders or retainers in the housing surrounding the rotor or armature and extend to make electrical contact with the rotor in the area of the interleaved fingers. As the rotor is rotated by the driving mechanism each brush in turn alternately makes contact with the positive and negative polarities of the interleaved fingers of the rotor. Each brush is paired with another brush which is arranged around the periphery of the rotor to make electrical contact with the segmented rotor as it rotates so that when a brush is making contact with a positively charged rotor finger the brush that it is paired with is making contact with a negative polarity rotor finger. Electrical conductors are attached to the brushes in conventional fashion to carry the electrical energy signals produced by the brushes to suitable utilization devices to cause them to respond as desired to the polarized electrical signals. In one example, the controller may provide the successive alternate polarity electrical signals to a pair of co-acting solenoids to essentially operate them to produce a mechanical action to operate some device in alternate sequential fashion.

### DESCRIPTION OF THE DRAWINGS

FIG. 1. Is a general plan view of an apparatus constructed according to the teachings of this invention;

FIG. 2. Is a cross section view illustrating some of the detail of the rotor of an embodiment of the invention;

FIG. 3. Is an enlarged view illustrating the construction of a rotor in an embodiment of the invention;

FIG. 4. Is a diagrammatic illustration of a utilization device as an example of a typical use of an embodiment of the invention; and

FIG. 5. Is an illustration of means for applying the polarized electrical charge to the rotor of the disclosed embodiment.

### DESCRIPTION OF AN EMBODIMENT OF THE INVENTION

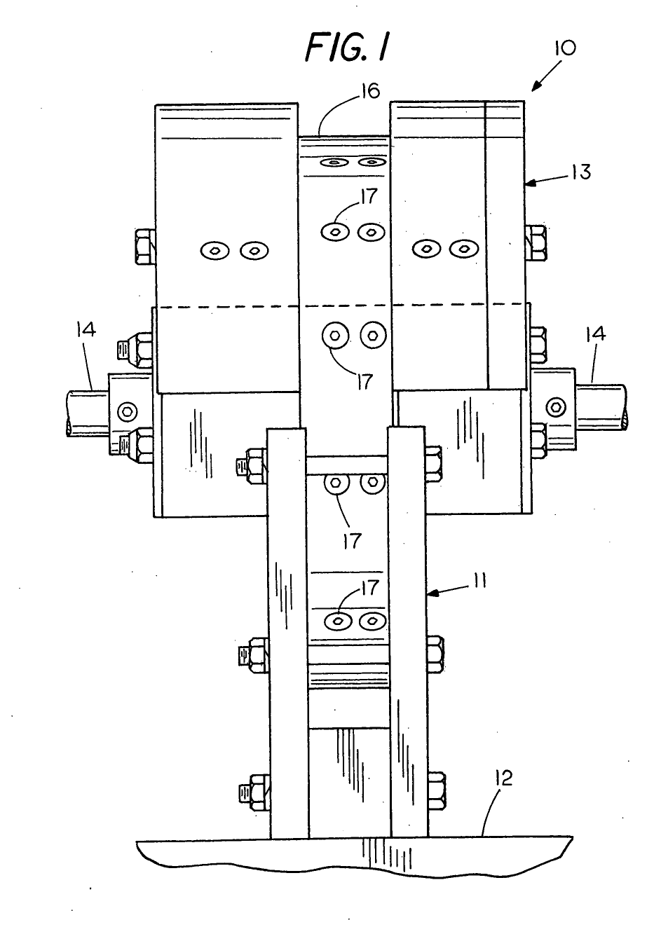

An apparatus constructed according to the teachings of the instant invention is illustrated in FIG. 1. The apparatus may be mounted for example on a suitable support post 11 on a stand or platform 12 enclosed with suitable housings generally designated by reference numerals 13 and 16. A rotor or armature, partly shown, is rotationally driven by a shaft 14. The shaft maybe conventionally driven by mechanical means such as a motor or some other mechanical device, not shown. The shaft may be physically supported outside of the housing if necessary.

A section of the housing 13 identified with reference numeral 16 surrounds the armature or rotor. Located on housing section 16 spaced apart around the periphery of the rotor are set screws 17 and springs for holding electrically conductive brushes which extend radially into the interior to make electrical contact with the rotor to produce electrical signals as the rotor rotates. As will be explained later in detail electrical conductors or wires, not shown, extend from the brushes in mountings 17 to utilization device which operate in response to the electrical signals developed by the brushes as the rotor rotates. The brushes are preferably conventional carbon brushes which make sliding contact with the rotor although roller style or ball style brushes made with suitable electrically conductive materials can also be used.

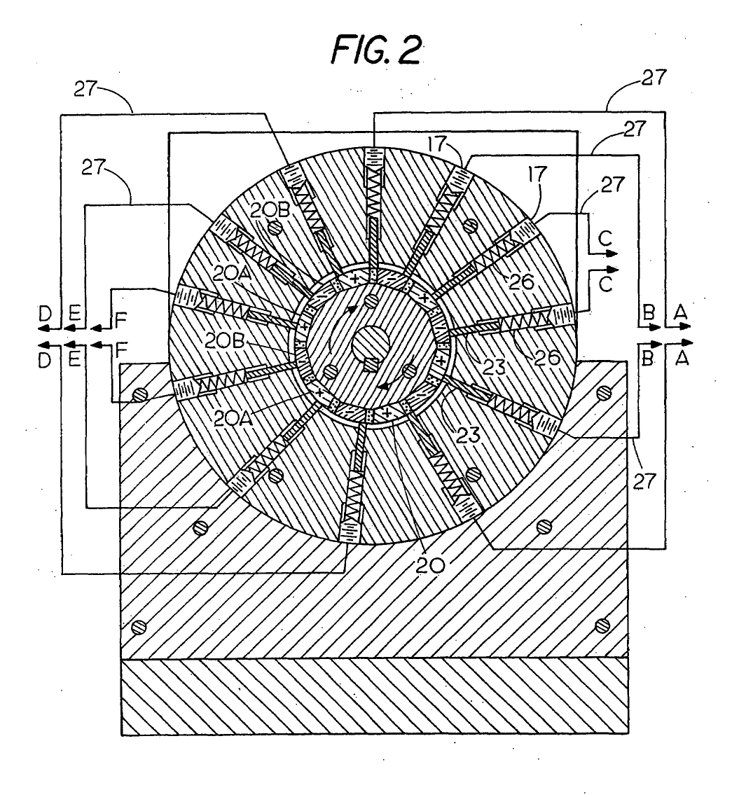

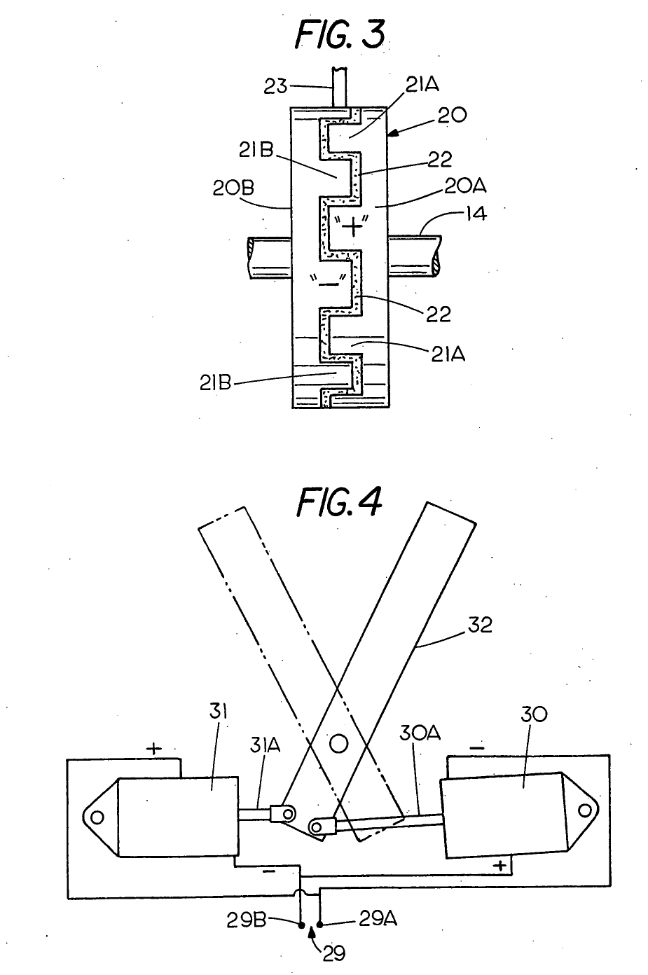

FIGS. 2 and 3. Illustrate some of the detail of the segmented rotor 20. Segments 20A and 20B are identical in construction both being made out of a highly electrical conductive material such as brass but are electrically insulated from one another by a suitable insulation material 22 such as Tefelon or ceramic or some other type of dielectric material. The body of each segment is a circular disc with peripherally spaced fingers extending parallel to the rotor shaft, i.e. axially, identified as 21A for segment 20A and 21B for segment 20B with the fingers being interleaved with one another but electrically insulated by suitable insulation 22. As mentioned earlier the rotor 20 comprising the two segmented sections is driven by a common shaft 14 which is electrically insulated from each rotor segment. By means not shown in FIG. 2 or 3 segment 20A is electrically polarized positive and segment 20B is electrically polarized negative. Reference numeral 23 identifies a diagrammatic form of an electrical brush which makes sliding electrical contact with the rotor fingers 21A and 21B and the intermediate insulation alternating between the positive and negative polarities and neutral as the rotor is rotated by shaft 14 to produce alternate positive and negative polarity electrical signals or voltages with zero or neutral voltage in between at the respective brushes.

FIG. 2. is a cross sectional view taken along a viewing line which passes vertically through the interleaved fingers or extensions of the segmented rotor. The embodiment of the invention is illustrated by showing a typical arrangement of a series of twelve brushes 23 peripherally spaced around the exterior of the rotor 20. Each of the brushes is mounted in a brush mount or retainer 17 in a conventional fashion being held in place by a spring or other compression member 26 to ensure that each brush is held radially firmly against the rotor to ensure a good sliding electrical contact as the rotor is rotated.

Similarly, in conventional fashion, electrical conductors or wires 27 extend from a connection to the brushes through the brush mounts 17 to carry the electrical signals produced by the brushes as the rotor segments are rotated. In this illustrated embodiment comprising twelve brushes each brush is paired with another peripherally spaced brush in such a fashion that when one of the pair of brushes is in contact with the positive polarity segment of the rotor, which is identified as 20A in this illustration, the other paired brush is in contact with the other half of the segmented roller namely 20B so that one of the associated conductors 27 is at a positive polarity and the other is at a negative polarity.

As the rotor is rotated the paired brushes sequentially reverse polarity, that is the one that had been positive becomes negative and vice versa. There is one exception. As the rotor rotates each brush of a pair is momentarily and simultaneously in contact with the insulation between the interleaved fingers of the segmented rotor so that neither of the pair has a polarized electrical charge, i.e., the voltage is neutral. In the illustration of FIG. 2 the brushes associated with conductors 27A constitute one set or pair of brushes, 27B another set, 27C another pair, and sets 27D, E and F each constitute a separate pair or set of brushes. As mentioned earlier with respect to the illustrated embodiment, during each revolution both brushes of a pair momentarily contact the insulation between the interleaved fingers of the segmented rotor so each brush must be dimensioned so that when it is in the insulated zone it is not making contact with the electrically conductive portion of either segment of the rotor and it is neutral and has no electrical charge.

FIG. 4. illustrates, as an example, a type of utilization device which can be operated by the electrical controller of the instant invention. The terminals identified by reference 29 in FIG. 4. are connected to the signal outlets or conductors 27 associated with a pair of brushes such as illustrated in FIG. 2. As an example for illustrative purposes only conductors 27A would be connected to terminals 29A and 29B. When a positive polarity signal appears at the terminal 29B and correspondingly a negative polarity signal at 29A electrically operated solenoid 30 receives a positive polarity signal at its positive input and a negative polarity signal at its negative input and therefore it would be energized so that its piston 30A would be extended to drive lever 32 to a position such as illustrated in solid line in FIG. 4. When the polarities on conductors 27A reverse, solenoid 31 becomes energized and solenoid 30 is deenergized so that piston 31A extends driving 30A back into the body of solenoid 30 and pulling lever arm 32 into the position as illustrated by dashed or phantom lines. The continuous repetitive signal developed by the illustrated embodiment of the invention and fed to the utilization device of FIG. 4. can be utilized to automatically and squentially move articles if necessary or for any number of a variety of actions in a repetitive cyclical manner. The electrical signal from the segmented rotor is sent directly to the utilization devices so there is no requirement for amplification or intermediate relays or microswitches or the like for energizing the utilization devices.

The number of brushes and the number of interleaved extensions or fingers for a segmented rotor 20 depends upon the nature of the system which the instant invention is used to control. The number and repetition rate of the signals needed in order to operate utilization devices for each revolution of the rotor also is determined according to the use to which the invention is put. The speed at which the rotor is rotated and the number of interleaved fingers will determine the frequency at which the developed electrical signals will alternate between the positive and negative polarities.

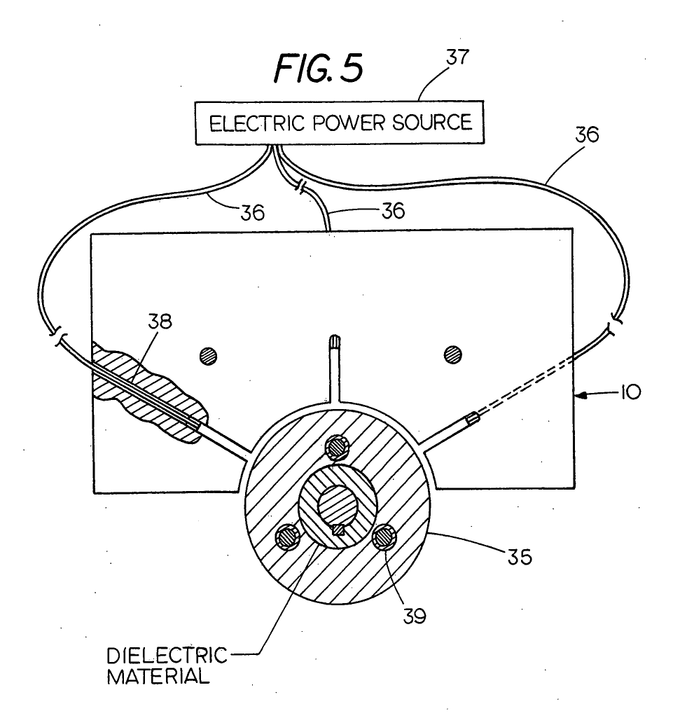

FIG. 5 Illustrates a manner in which the segmented rotor, part of which is shown in cross-section and identified by reference numeral 35, may receive electric power or energy to polarize the respective segments positively and negatively. Typically, and for illustration purposes only, a set of three conductors identified by reference numeral 36 are attached or connected in conventional fashion to a conventional electric power source 37 and pass through openings or passageways 38 in housing 10 into contact with electrical brushes, not shown, similar to those described hereinabove, which make electrical contact with one half of the segmented rotor. In corresponding fashion the electric power source 37 also provides the opposite polarity voltage or charge to the other half of the segmented rotor. The brushes for this purpose are arranged to contact the respective halves of the segmented rotor directly to the body of the rotor segment to maintain the positive or negative charge continuously on the same half of the rotor as the rotor is rotated. Also, FIG. 5 illustrates a set of insulated or dielectric bushings 39 which insulatively hold together the two sections of the segmented rotor.

The versatility of the instant invention, as described hereinabove with respect to the operation of solenoids can be further illustrated. For example, FIG. 2 illustrates six sets of brushes which produce alternately polarized electrical signals sequentially and continuously as the rotor is rotated. In an automatic production line, for example, one having six separate stages for performing some operation on a product, each of the stages can be spaced along a continuous belt carrying the product from stage to stage. Each of the stages typically can be energized or operated by the signal from a separate pair of conductors so that each of the six stages is energized or actuated sequentially as the product is carried down the production line by the continuous belt. In that way the product is operated on sequentially under the control of the signals developed by the embodiment of the invention illustrated in FIG. 2. It should be understood that in some instances the invention may be used to provide more or less than six control signals and the rotor(s) can be designed to provide a large number of sequential repetitive reverse polarity signals and, except for practical limitations, a large number of interleaved fingers on the polarized segmented rotor(s) can be designed to produce almost an unlimited number of sequential oppositely polarized repetitive control signals. As mentioned earlier the repetitive rate of the developed signals also depends in part on the speed of rotation of the rotor.

I claim:

1. A controller for producing sequential alternating polarity electrical signals, comprising:
a) a two-piece segmented cylindrical rotor, each segment made of solid electrically conductive material and electrically insulated from one another;
b) each segment having multiple equally spaced apart fingers around its periphery, said fingers interleaved with and insulatively spaced from corresponding fingers on the other segment;
c) an outer housing for said rotor;
d) a shaft insulatively coupled to said rotor for rotationally driving said rotor;
e) means for applying a positive polarity energy source to one rotor segment and a negative polarity to the other segment;
f) a pair of electrical brushes in said housing in contact with the fingers of the rotor segments as the rotor is rotated to alternately produce positive and negative polarity electrical signals at each brush;
g) said brushes located around the periphery of the rotor such that when one of the brushes is in contact with one polarity segment the other brush is in contact with the other polarity segment; and,
h) electrical conductors connected to each of said brushes for carrying the electrical signals to a utilization device.

2. The invention as described in claim 1, further including multiple pairs of electrical brushes in said housing spaced around the periphery of said rotor in contact with the rotor fingers.

3. The invention as described in claim 2 wherein each of said pairs of brushes is electrically connected to a separate utilization device.

4. A controller for producing electrical signals for utilization devices, said controller comprising:
a) a pair of electrically conductive generally circular rotor members insulatively separated from one another;
b) said rotor members having circumferentially spaced interleaved fingers extending in an axial direction;
c) said rotor members electrically charged with opposite polarities;
d) a shaft for rotationally driving said rotor; and
e) a pair of electrically conductive brushes circumferentially spaced in contact with said fingers to produce alternately polarized electrical signals at each brush as said rotor rotates.

5. The invention as described in claim 4 further including electrical conductors attached to said brushes for carrying the electrical signals from said brushes to utilization devices.

6. The invention as described in claim 4 wherein each of the pair of brushes is located such that when one of the pair is in contact with a polarized finger the other brush of the pair is in contact with an oppositely polarized finger.

7. The invention as described in claim 6 further including multiple pairs of brushes and electrical conductors attached to said brushes for carrying the electrical signals to utilization devices.
